(19) United States
(12) Patent Application Publication
(10) Pub. No.: US 2014/0138968 A1
(43) Pub. Date: May 22, 2014

(54) Flexible Food Skewer System

(71) Applicants: Todd R. Gentry, Winfield, KS (US); James H. Jones, Wichita, KS (US); Richard S. Smith, Hot Springs, AR (US); Louis Chalfant, Hot Springs, AR (US)

(72) Inventors: Todd R. Gentry, Winfield, KS (US); James H. Jones, Wichita, KS (US); Richard S. Smith, Hot Springs, AR (US); Louis Chalfant, Hot Springs, AR (US)

(21) Appl. No.: 14/012,698

(22) Filed: Aug. 28, 2013

Related U.S. Application Data
(63) Continuation-in-part of application No. 13/339,105, filed on Dec. 28, 2011, now abandoned.
Application No. 13/339,105 is a continuation of application No. 12/800,241, filed on May 11, 2010, now abandoned.
Application No. 12/800,241 is a continuation-in-part of application No. 10/798,155, filed on Mar. 9, 2004, now Pat. No. 8,042,850.

(51) Int. Cl. A47J 43/18; A47J 37/04

(52) U.S. Cl. CPC A47J 43/18; A47J 37/049
USPC 294/61

(57) ABSTRACT

A flexible food skewer system for providing versatile cooking upon a grill. The flexible food skewer system includes an elongated flexible member, a loop extending from an end and formed in part from the flexible member, and a piercing element extending from an opposite end of the flexible member are provided. In use, the user is able to manipulate the shape of the flexible member about other food items on the grill while allowing the loop and piercing implement to be exterior of the grill if desired. A second piercing implement may be provided instead of the loop. In further alternative embodiments of the invention, two or more flexible skewer systems may be intertwined to provide greater and reinforced food carrying capacity. Various alternative structures are provided to enable secured, releasable interlocking of the intertwined skewer systems.

### BACKGROUND OF THE INVENTION

1. The Technical Field

The present invention relates generally to cooking utensils, and more specifically it relates to a flexible food skewer system for providing versatile cooking upon a grill, among other food cooking environments.

2. Description of the Related Art

Skewers have been in use for years for cooking food (e.g. steak, chicken, vegetables) upon a grill or other cooking environment. A conventional skewer is comprised of a rigid, straight rod structure having an end member and a pointed end. A conventional skewer is typically constructed of a rigid metal rod or wood rod.

The user of a conventional skewer first inserts the food items upon the shaft of the conventional skewer and then positions the skewer upon the grill. Since a conventional skewer is a rigid straight structure, the user typically positions the entire skewer upon the grill. If the user attempts to extend the end member of the skewer outside of the grill cover, the grill cover will sometimes not completely close. In addition, since the conventional skewer is a rigid and straight structure, it can be difficult to efficiently utilize the grill surface area when other food items such as chicken legs, steaks, sausage and the like are on the grill. A further problem with conventional skewers is that they can be difficult to utilize within food items with bones such as chicken legs and wings since they only pass through the meat portion in a straight line.

While these devices may be suitable for the particular purpose to which they address, they are as suitable for providing versatile cooking upon a grill. Conventional skewers are not suitable for versatile cooking of food items.

In these respects, the flexible skewer system according to the invention substantially departs from the conventional concepts and designs of the prior art, and in so doing provides an apparatus primarily developed for the purpose of providing versatile cooking upon a grill.

### SUMMARY OF THE INVENTION

In view of the foregoing disadvantages inherent in known types of skewers now present in the prior art, the present invention provides a new flexible skewer construction wherein the same can be utilized for providing versatile cooking upon a grill.

The general purpose of the present invention, which will be described subsequently in greater detail, is to provide a new flexible skewer system that has many of the advantages of the skewers mentioned heretofore and many novel features that result in a new flexible skewer system which is not anticipated, rendered obvious, suggested or even implied by any of the prior art skewers, either alone or in any combination thereof.

To attain this, the present invention generally comprises an elongated flexible member, a loop extending from an end of the flexible member and a piercing implement extending form the opposite end of the flexible member. The flexible member is preferably comprised of a stainless steel cable. In use, the user is able to manipulate the shape of the flexible member about food items on the grill while gripping the loop and piercing member, and further allowing the loop and piercing implement to be exterior of the grill. Alternatively, a second piercing implement may be utilized instead of a loop.

In another embodiment of the invention, the invention comprises a cooking utensil, for retaining, by sequential impalement thereon, one or more food items to be cooked. An elongated flexible high-temperature resistant member, having first and second ends, is provided. A piercing member is affixed to the first end of the elongated flexible high-temperature resistant member. The second end of the elongated flexible high-temperature has a gripping looped formed thereon, and a retaining member disposed longitudinally between the gripping loop and a remaining portion of the flexible member.

Another embodiment of the invention comprises a cooking utensil, for retaining by sequential impalement thereon, one or more food items to be cooked, wherein a flexible, high-temperature resistant member is provided, having first and second ends. A piercing member is affixed to the first end of the elongated flexible high-temperature resistant member. The second end of the elongated flexible high-temperature resistant member has a gripping loop formed thereon, and a retaining portion may be disposed longitudinally between the gripping loop and a remaining portion of the flexible member.

There has thus been outlined, rather broadly, the more important features of the invention in order that the detailed description thereof may be better understood, and in order that that the present contribution to the art may be better appreciated. There are additional features that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description as illustrated in the drawings. The invention is capable of other embodiments and of being practiced and carried out in various ways. Also, it is to be understood that the phraseology and terminology employed herein are for the purpose of the description and should be regarded as limiting.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with accompanying drawings, in which like reference characters designate the same or similar parts throughout the several views, and wherein:

FIG. 1 is a top view of the present invention;

FIG. 2 is a top view of the present invention, wherein two units are connected to one another;

FIG. 3 is a top view of an alternative embodiment utilizing two piercing implements;

FIG. 4 is a top view of the present invention with food attached upon the flexible member;

FIG. 5 is a top view of the flexible member with food attached and positioned upon the grill;

FIG. 6 is a top view of the flexible member with food attached and positioned upon the grill with the piercing implement and the loop extending out of the front portion of a grill;

FIG. 7 is an upper perspective view of the distal ends of the present invention extending from a grill;

FIG. 8 is a front view of the present invention positioned within a marinade;

FIG. 9 is a front view of the present invention positioned within a deep fryer;

FIG. 10 is a perspective view of an alternative cooking utensil, of an alternative embodiment of the present invention, showing an alternative sleeve arrangement for the gripping loop formed on an end opposite the piercing member;

FIG. 11 is a perspective view of an alternative cooking utensil according to the embodiment of FIG. 10, showing how it may be looped upon itself, to hold items skewered thereon;

FIG. 12 is a plan view of an alternative composite cooking utensil according to an alternative embodiment, wherein two cooking utensils according to the embodiment of FIG. 10 are shown interconnected to one another;

FIG. 13 is a plan view of an alternative cooking utensil, of an alternative embodiment of the invention, showing a gripping medallion, positioned proximate the gripping loop;

FIG. 14 shows the cooking utensil of FIG. 13 looped upon itself, so as to capture food items skewered thereon;

FIG. 15 is a further view of the cooking utensil of FIGS. 13-14, showing in particular the structure for crimping/capturing the cable in the gripping medallion;

FIG. 16 is a plan view of an alternative composite cooking utensil according to an alternative embodiment, wherein two cooking utensils according to the embodiment of FIGS. 13-15 are shown interconnected to one another;

FIG. 17 is a front perspective view of a an alternative embodiment of the skewer system of the present invention;

FIG. 18 is a top plan view of the removable handle portion of the skewer system of FIG. 17;

FIG. 19 is a bottom plan view of the removable handle portion of the skewer system of FIG. 17;

FIG. 20 is a side elevational view of the removable handle portion of the skewer system of FIG. 17;

FIG. 21 is an opposite side elevational view of the removable handle portion of the skewer system of FIG. 17;

FIG. 22 is a rear end elevational view of the removable handle portion of the skewer system of FIG. 17;

FIG. 23 is front end elevational view of the removable handle portion of the skewer system of FIG. 17;

FIG. 24 is a partial top perspective view of the piercing member and high-temperature resistant member of the skewer system of FIG. 17;

FIG. 25 is a top plan view of the skewer system of FIG. 17 having the removable handle of FIGS. 18-23 removed;

FIG. 26 is a rear perspective view of the food stop/handle connector of the skewer system shown in FIG. 25;

FIG. 27 is a side elevational view of the food stop/handle of FIG. 26;

FIG. 28 is a front end elevational view of the food stop/handle connector of FIG. 26;

FIG. 29 is a rear end elevational view of the food stop/handle connector of FIG. 26;

FIG. 30 is a side perspective of the food stop/handle connector of FIG. 26 in a separated position adjacent the removable handle portion of FIG. 18;

FIG. 31 is a side perspective of the food stop/handle connector of FIG. 26 in an inserted position in the removable handle portion of FIG. 18; and

FIG. 32 is a side perspective of the food stop/handle connector of FIG. 26 in a secured position in the neck of the removable handle portion of FIG. 18.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further to the extent that any numerical values or specifics of materials, etc., are provided herein, they are to be construed as exemplifications of the inventions herein, and the inventions are not to be considered as limited thereby.

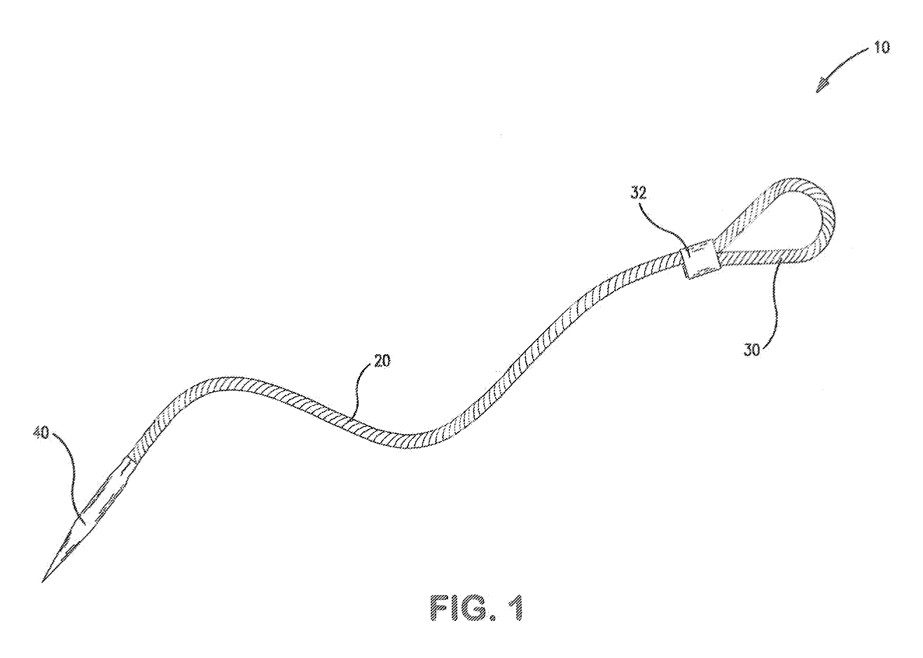

Turning now descriptively to the drawings, in which similar reference characters denote similar element throughout the several views, FIGS. 1-9 illustrate a flexible skewer system 10, which comprises an elongated flexible member 20, an enlarged end member 30, such as the loop as shown in FIG. 1, extending from an opposite end of the flexible member 20 and a piercing implement 40 extending from an opposite end of the flexible member 20. The flexible member 20 is preferably comprised of a stainless steel cable. In use, the user is able to manipulate the shape of the flexible member 20 about other food items on the grill 12 by gripping the loop and piercing member and further allowing the enlarged end 30, such as the loop shown in FIG. 1, and the piercing implement 40 to be exterior of the grill 12. Alternatively, a second piercing implement 40 may be utilized instead of the enlarged end member.

The elongated flexible member 20 has a first end and a second end as shown in FIG. 1 of the drawings. The flexible member 20 is preferably comprised of a flexible structure as illustrated in the drawings. The flexible member 20 is preferably comprised of a flexible metal cable (e.g. stainless steel cable).

The flexible member 20 preferably has a length greater than approximately twenty inches to accommodate a number of food items and providing a sufficient length to allow the ends to both extend outside of the grill 12. The flexible member has a diameter of approximately 3/32 inches.

An enlarged end member 30 preferably extends from the end of the flexible member 20 opposite the piercing implement 40 as shown in FIG. 1 of the drawings. The enlarged end member 30 may be comprised of various structures including but not limited to a loop, eyelet, tee-member, ferrule, other structures to be described herein and the like. As shown in FIG. 1 of the drawings, a sleeve 32 is secured to the flexible member 20 to secure the first end to the flexible member 20 thereby forming the loop.

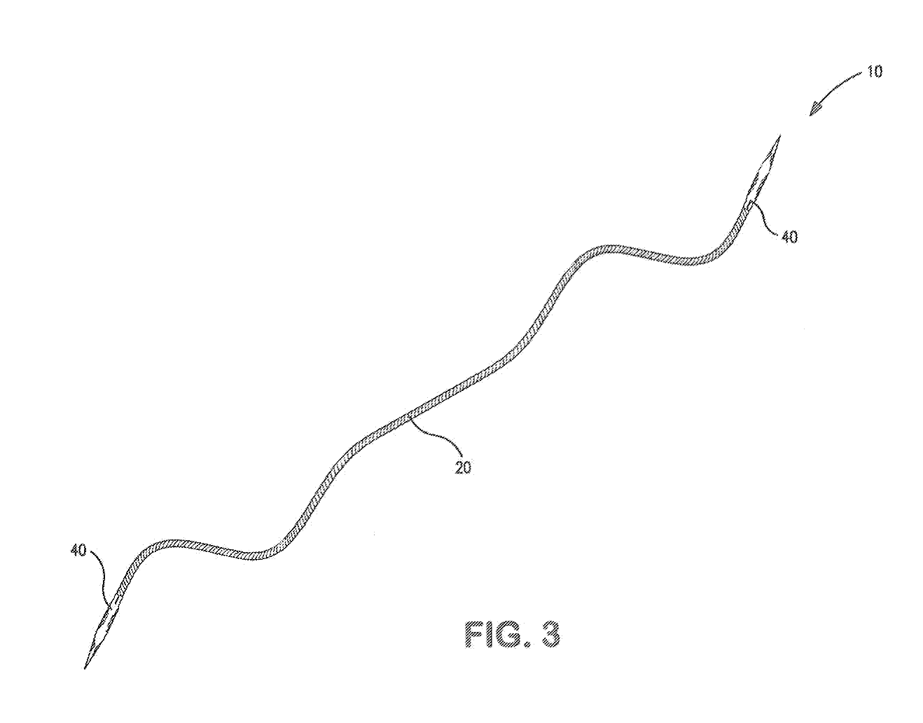

The piercing implement 40 extends from the second end of the flexible member 20 opposite to the end member 30 and an overall diameter greater than the diameter of flexible member 20 to aid in retaining food items on the flexible member 20 during use as shown in FIG. 1 of the drawings. The piercing implement 40 preferably has a pointed end for providing easy insertion into food items such as meat and vegetables. As shown in FIG. 3 of the drawings, a second piercing implement 40 may be attached to the first end of the flexible member 20 instead of the end member 30.

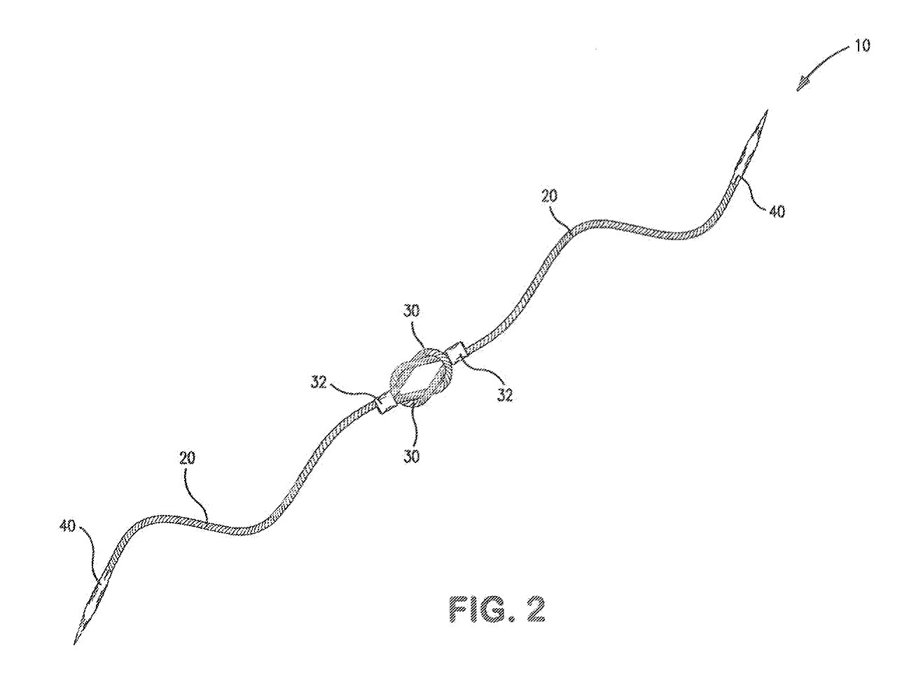

The user first determines the desired length they will require for the flexible skewer 10 based upon the amount and size of food items. FIG. 2 illustrates two skewers 10 together by inserting the flexible skewers 10 through the loop of the opposing flexible skewer 10.

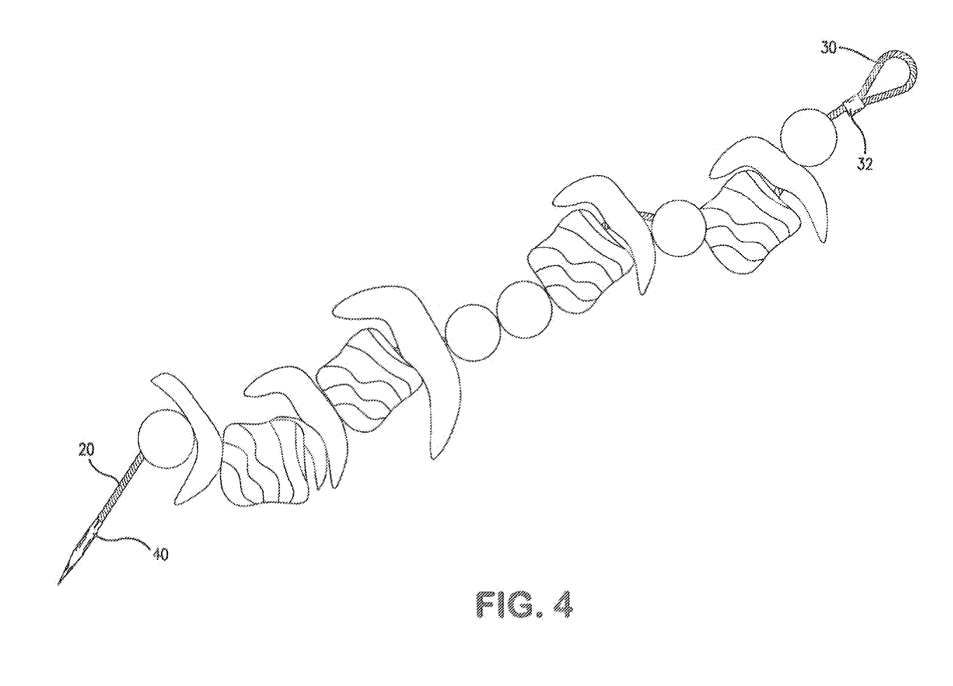

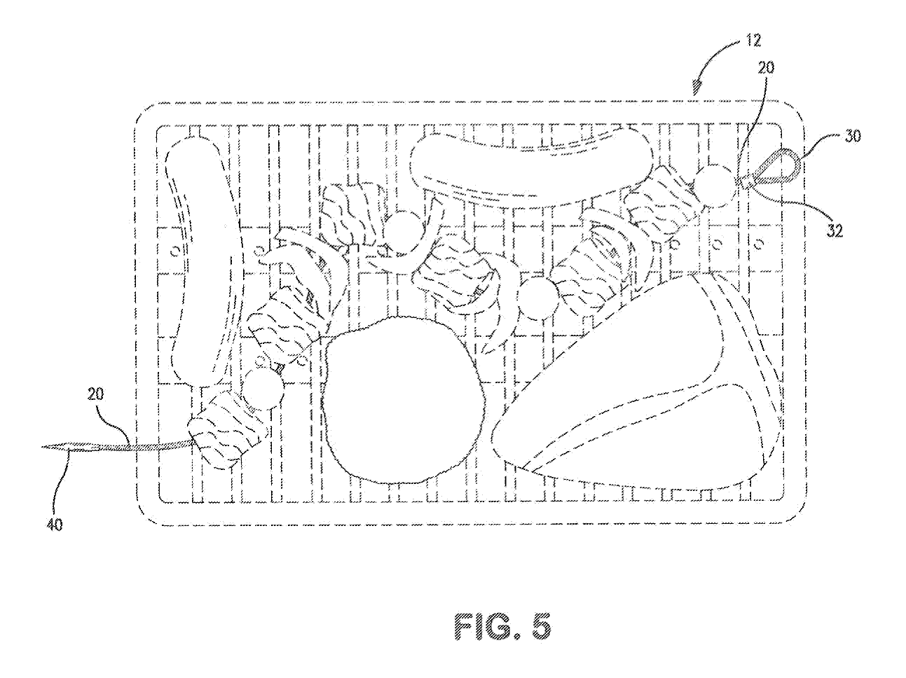

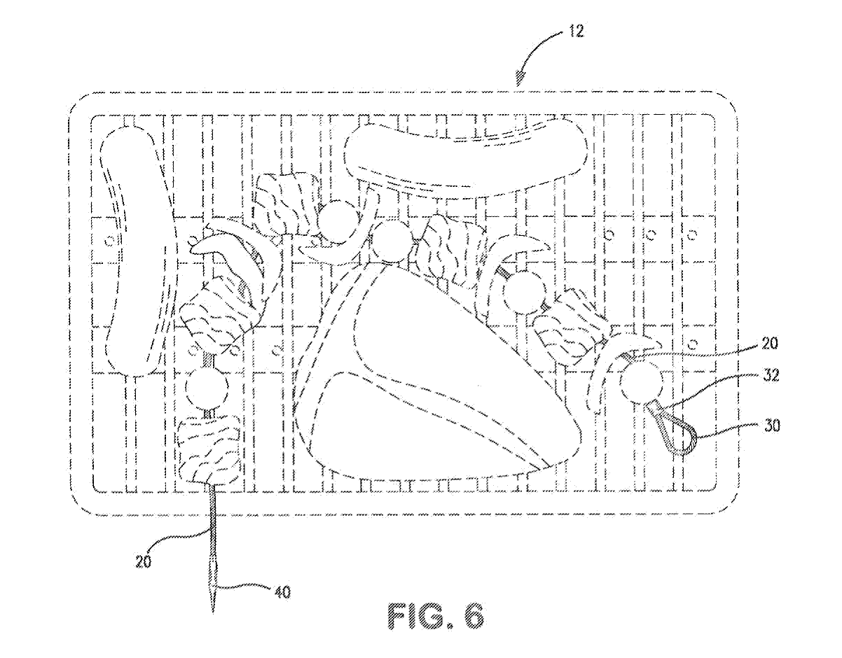

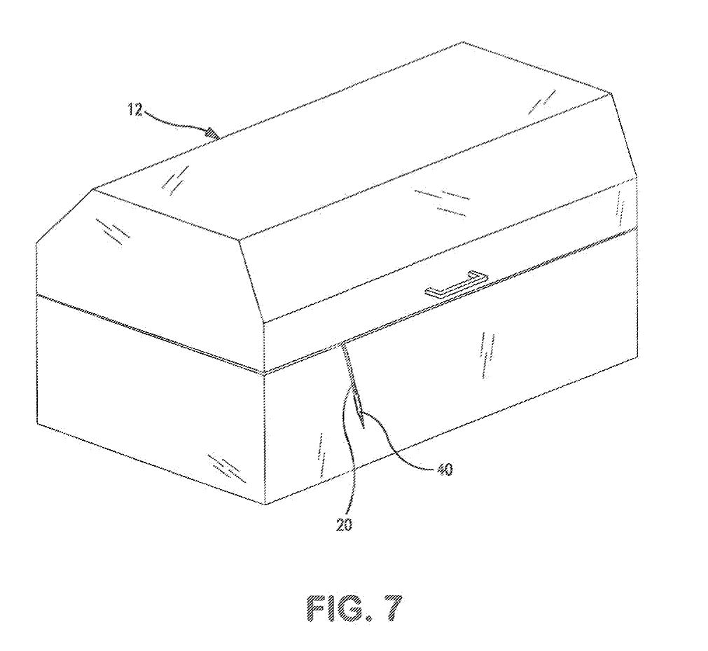

The user then attaches one or more food items upon the flexible member 20 by inserting the piercing implement 40 through thereof as shown in FIG. 4 of the drawings. The user then positions the flexible skewer 10 upon a cooking surface such as grill 12 as shown in FIGS. 5 and 6 of the drawings. The user then typically manipulates, such as by gripping the enlarged end member 30 and piercing member 40, the flexible skewer 10 about other food items on the cooking surface that are not attached to the flexible skewer 10 as further shown in FIGS. 5 and 6 of the drawings. The user also positions at least one end of the first flexible member 20 external of the cooking surface as shown in FIGS. 5 through 7 of the drawings. The user may then close the cover of the grill 12 with the flexible member 20 bending underneath the cover to allow for full closing of the as shown in FIG. 7 of the drawings.

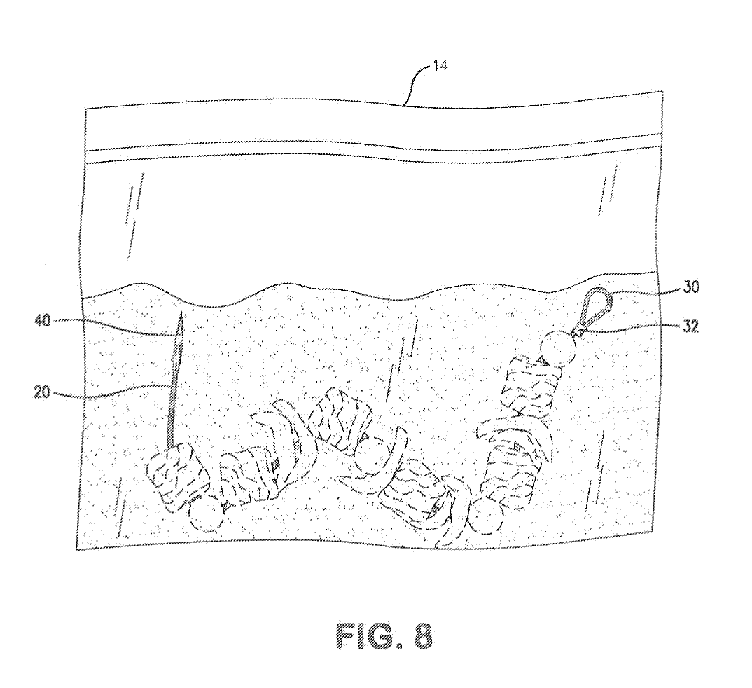

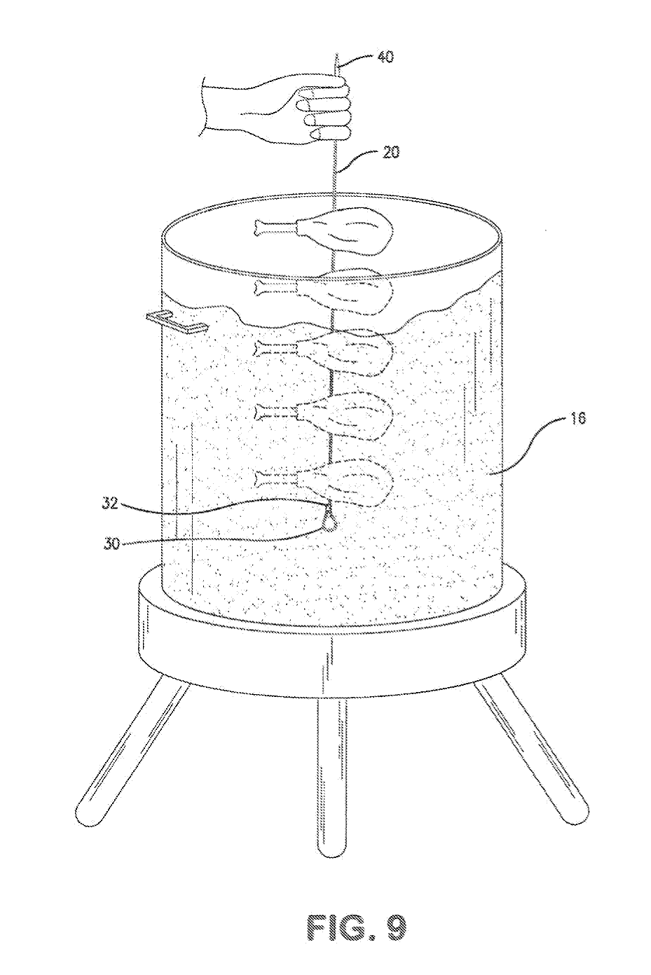

FIGS. 8 and 9 illustrate additional alternative uses of the present invention. FIG. 8 illustrates marinating various food items within a marinade bag 14 before cooking the food items. FIG. 9 illustrates positioning the present invention within a deep fryer 16 for cooking various food items. The present invention may also be utilized in various other commonly utilized cooking environments.

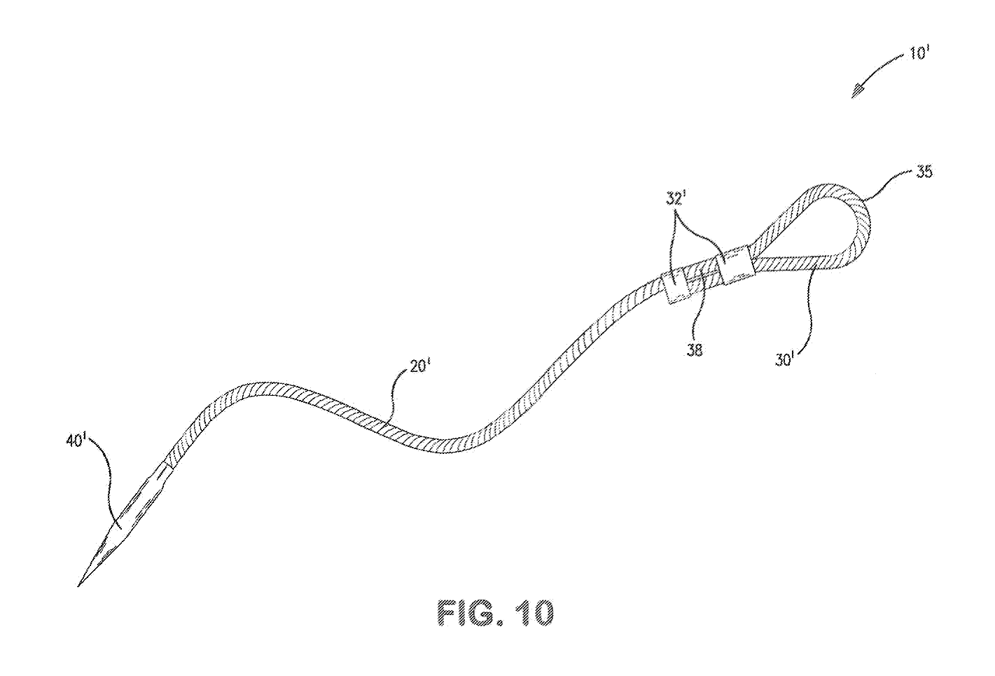

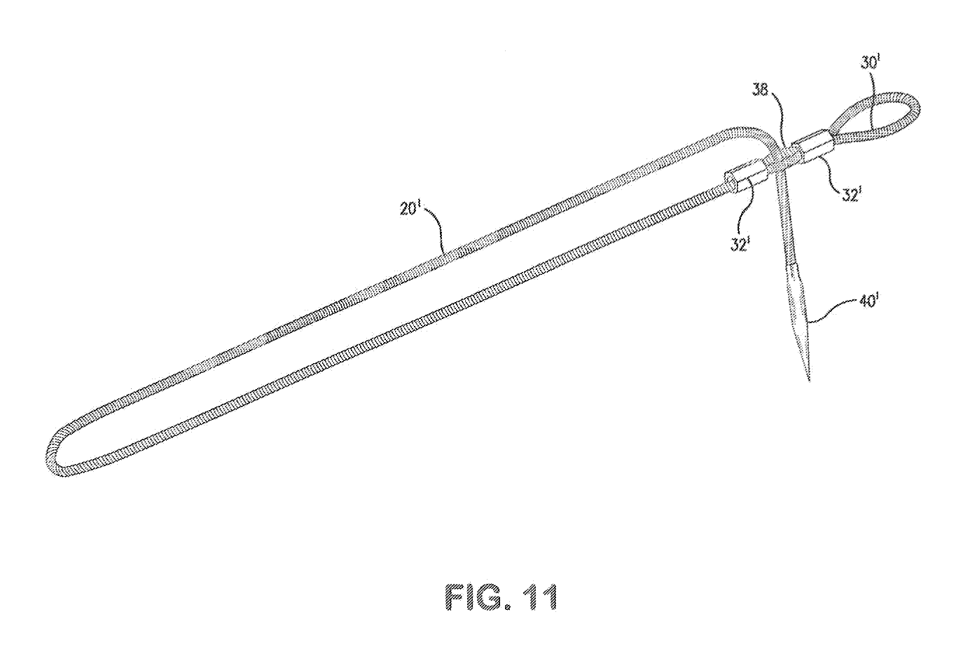

FIGS. 10 and 11 illustrate a cooking utensil according to an alternative embodiment of the invention. Structural elements which are similar or analogous in function to corresponding structural elements shown and described with respect to the embodiments of FIGS. 1-9 are provided with like reference numerals, augmented by a prime (′).

Flexible skewer system 10′ is formed with flexible member (cable) 20′, having end member 30′ formed at one end, and having piercing members 40′ affixed to the opposite second end of end member 30′. To secure the end of flexible member 20′ to form end member 30′, two sleeves 32′ are provided, one connecting the extreme tip of flexible member 20′ to a portion of flexible member 20′ distal to the extreme tip, and a second sleeve 32′ positioned between the first sleeve 32′ and bight 35 of the loop. The first and second sleeves 32′ create a gap between juxtaposed adjacent portions of the flexible member 20′ to form a second, smaller loop 38. In preferred versions of this embodiment, all of the components making up each flexible skewer 10′ is fabricated from high-temperature (and/or flame) resistant and food-safe materials, such as stainless steel for flexible member 20′. Sleeves 32′ and piercing elements 40′ likewise may be fabricated from stainless steel or similar high-temperature (and/or flame) resistant and food safe materials. In embodiments that are fabricated from stainless steel (both the flexible member 20′ and piercing element 40′), when piercing element 40′ is left off of the grill, so as to extend even a relatively short distance, because stainless steel has a relatively a high thermal conductivity for heat dissipation, it may be possible to grasp flexible skewer system 10′ by piercing element 40′ barehanded (without gloves), even after a substantial period of time over the grill. Accordingly, alternative embodiments of the invention may be fabricated from other high temperature resistant, high thermal conductivity materials, that have lower than, e.g., non-stainless steel cable, copper, etc. Grasping by the piercing element 40′ is done to raise flexible skewer system 10′ with or without the loop, since the wider diameter of the piercing element 40′ compared to the flexible member 20′ (FIGS. 1-7) inhibits food articles (raw or cooked) from sliding off the flexible skewer system 10′.

According to one method of use, shown in FIG. 1, a single skewer system 10′ may be looped upon itself, after food items (not shown) have been skewered thereon, and the piercing element 40′ has been passed through smaller loop 38. The resulting structure is capable of being carried, or even suspended, via bight 35 of the end loop 30′.

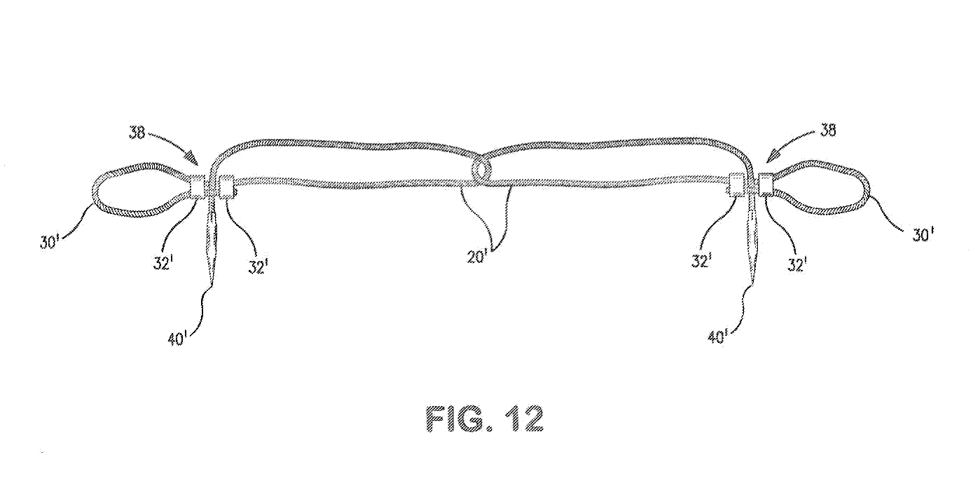

In an alternative method of use, loop 38 permits two flexible skewer systems 10′ to be intertwined, as shown in FIG. 12. In use, food items (not shown) may be impaled upon each skewer system 10′, along the portion of flexible member 20′, between a point approximately half-way between sleeves 32′ and piercing element 40′, and then the flexible member 20′ will be crossed at 34′. Then, if desired, additional food items (not shown) may then be impaled upon each skewer system 10′, between crossing 34′ and the respective piercing element 40′. Then, the piercing element 40′ of each system 10′ is passed through loop 38 of the other system 10′, leaving end members 30′ free to be used as gripping loops, to facilitate handling of the intertwined flexible skewer systems 10′.

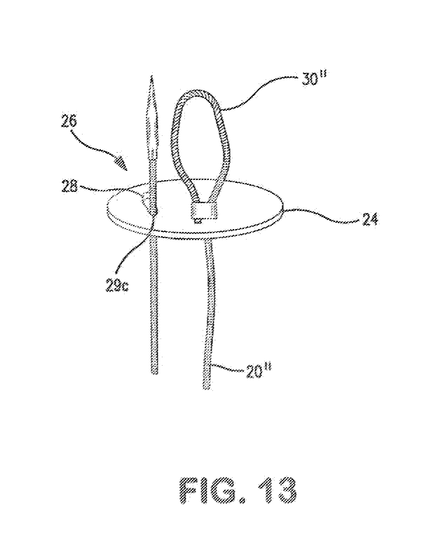

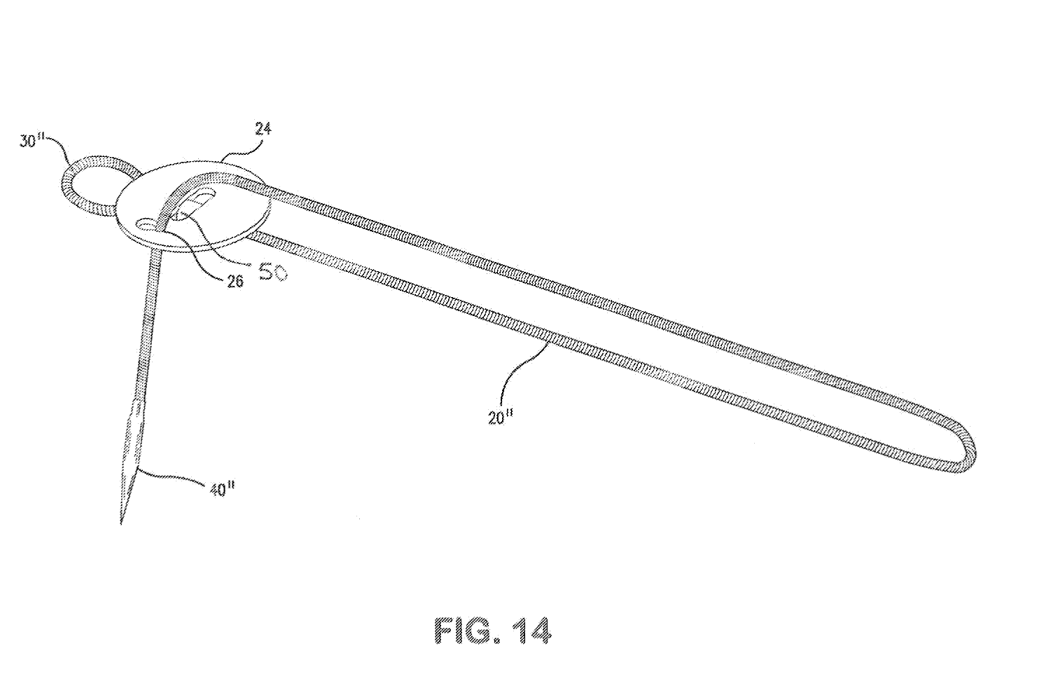

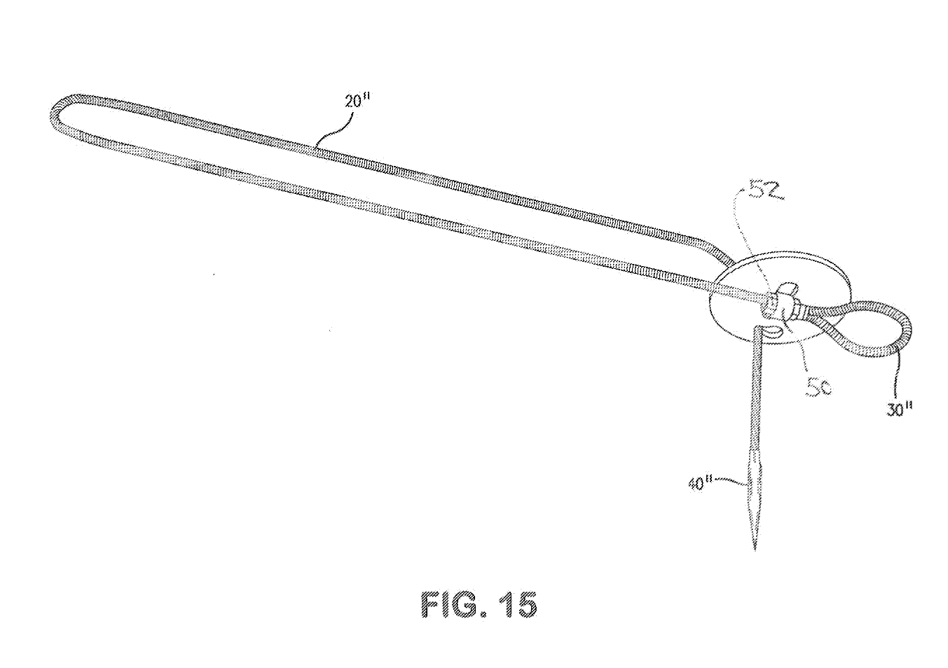

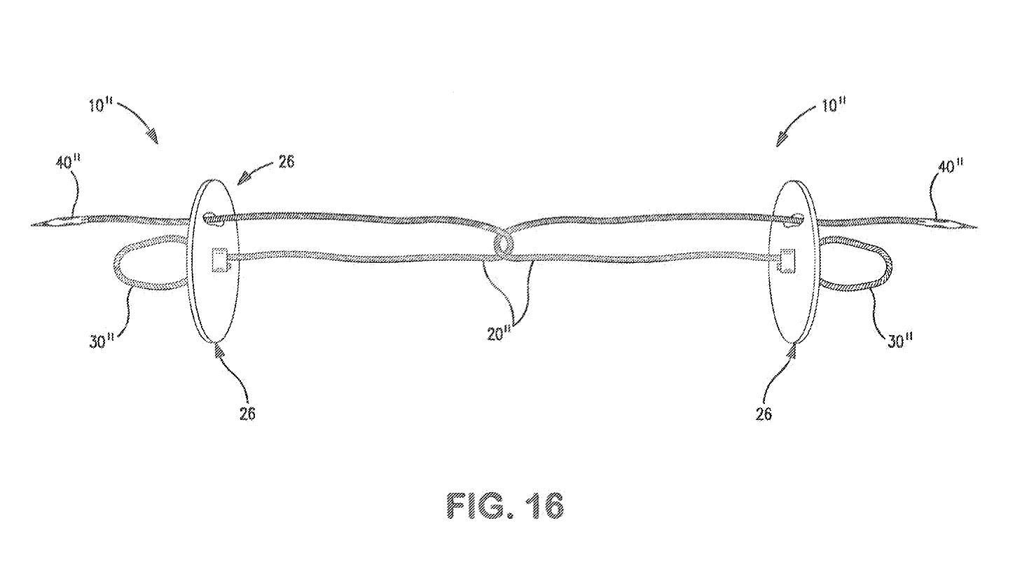

FIGS. 13-16 illustrate another embodiment of the invention, wherein structural elements which are similar are analogous in function to corresponding structural elements shown and described with respect to the embodiments of FIGS. 1-11 are provided with like reference numerals, augmented by a double prime (″). The embodiment of FIGS. 13-16 is similar to the embodiment of FIGS. 10-12, with the additional provision of a locking mechanism, to help hold the flexible skewer systems 10″ in their looped configurations. In this embodiment, instead of using pairs of spaced apart sleeves 32″ on each flexible member, a flat planar medallion or disk 24 (preferably fabricated from flame or high-temperature resistant and food safe metal material) is provided, through which a flexible member 20″ is passed. Each medallion or disk 24 may be affixed to its respective flexible member 20″ by crimping a portion 50 of the material forming medallion or disk 24 to flexible member 20″ either directly or through use of an intermediate collar 52 used to help form loop 30″ (see, e.g. FIGS. 14-15; no particular attachment method is intended to be illustrated by FIG. 13 or 16). As an alternative, an intermediate member, similar to sleeve 32′, may be affixed (e.g. by welding, brazing, etc.) to the medallion or disk 24 and then crimped (or welded, brazed, etc.) to flexible member 20″.

A teardrop or keyhole shaped opening 26 is formed in each medallion or disk 24, which has wider-diameter portion 28, which is large enough to permit the passage of a piercing element 40″, and a narrower width portion 29, which in turn is narrower than the diameter of flexible member 20″.

FIGS. 14 and 15 show how a single skewer system 10″ may be looped upon itself, and the piercing member 40″ passed through opening 26, and then flexible member 20″ is pushed sideways into the narrower portion 29, and gripped thereby. As with the embodiments of FIGS. 10-12, loop 30″ permits skewer system 10″ to be carried or suspended (during cooking), as well as facilitating cooking on a grill.

In use food items (not shown) will be placed on each of skewer systems 10″, in a manner similar to that described with respect to FIGS. 10-12. Piercing elements 40″ of the respective skewer systems 10″ will be passed through the openings 26 of the medallion or disks 24 of the corresponding other skewers systems 10″, and then the flexible members 20″ will be pulled into the narrower-width portions of the disks 24, into binding frictional engagement therewithin, to prevent the intertwined skewer systems 10″ from becoming undone, during handling.

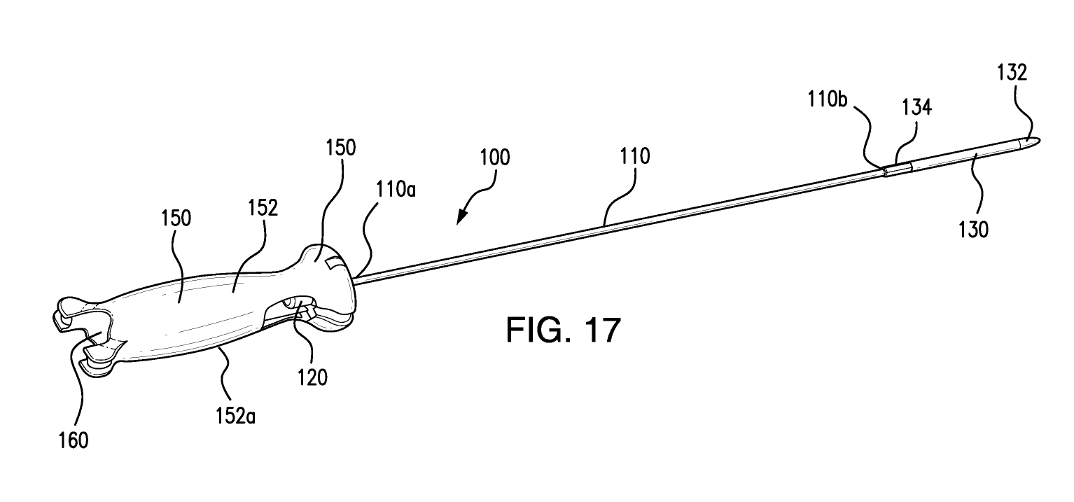

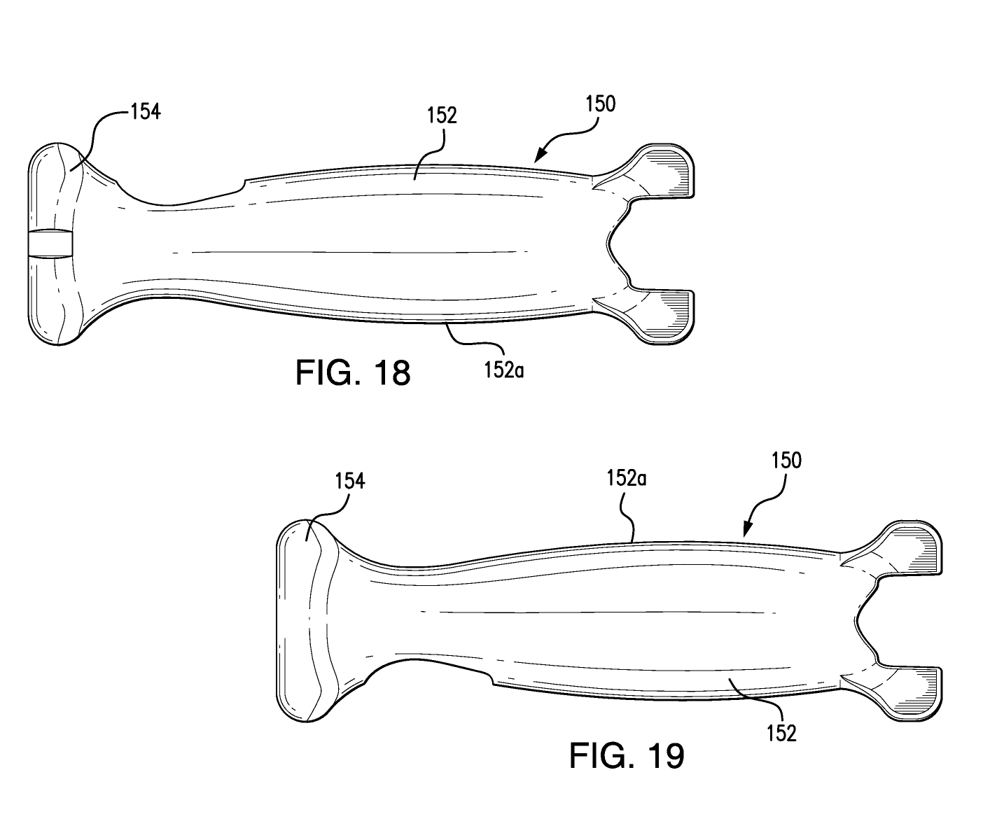

Referring now to FIGS. 17-32, there is illustrated still another embodiment of the skewer system of the invention, generally designated by reference numeral 110. In FIG. 17, skewer system 100 includes a slender, elongated flexible element 110 formed from a high temperature resistant materials, such as an austenitic stainless steel. The degree of flexibility of flexible element 110 is sufficient to permit the flexible element 110 to be arranged between the other food items positioned on the grill. The elongated flexible element 110 has opposed end portions 110a, 110b.

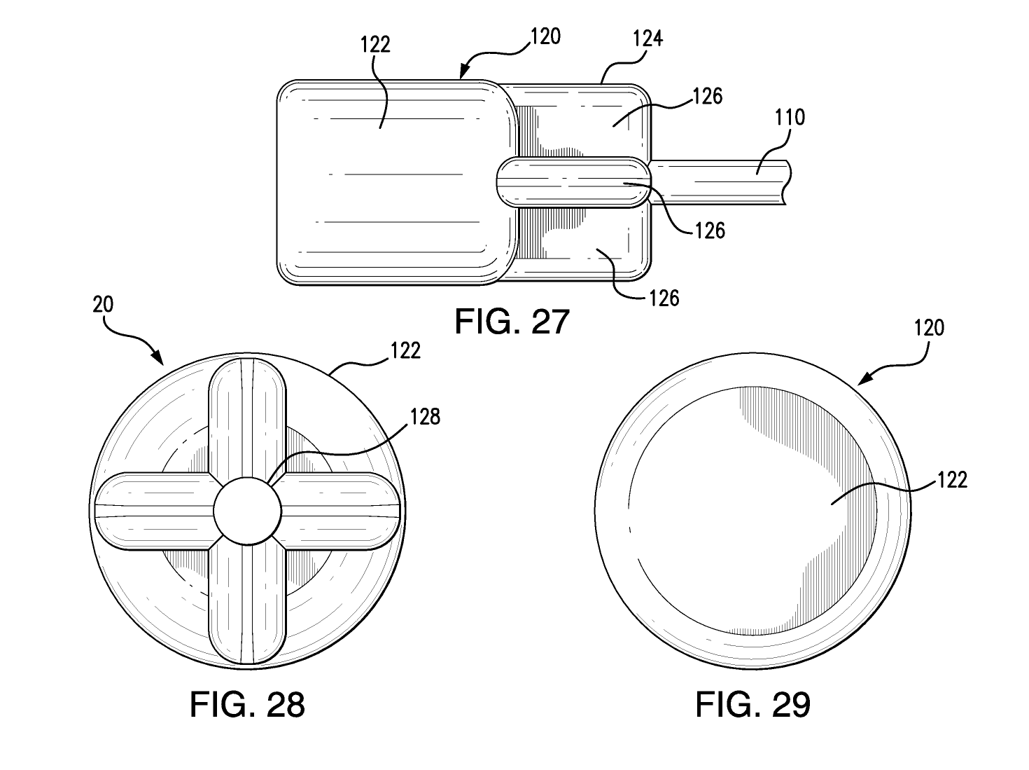

An enlarged food stop/handle connector 120 is suitably affixed to the end portion 110a of the flexible element 110 by conventional techniques and is intended to serve as a food stop to retain food items (not shown) being carried or retained on flexible element 110, as a direct manual gripping member, or as a handle connector for a removable handle member to be described to permit carrying of an end of the skewer system 100 before, during and after cooking on a grill surface or other cooking device. The food stop/connector is formed from a metal, such as stainless steel, a high temperature plastic, or other temperature resistant material. As seen in FIGS. 26-29 food stop/connector 120 has a rear cylindrical portion 122 having a diameter greater than the adjacent flexible element 110 (FIGS. 27 and 29). It is within the scope of the invention that rear cylindrical portion encompass other comparable configurations if appropriate to serve as a handle. The front portion 124 of food stop/connector 120 is provided with crossing members 126 to create four keying lugs 126a. The flexible element 110 extends into hole 128 formed central of the end of front portion 124 in which the food stop/connector 120 is secured against movement to the flexible connector 110 by a conventional securement technique (not shown).

Referring now to FIGS. 17, 24, and 25 the piecing member 130 is shown in attachment by a suitable technique to the end of the flexible wire end portion 110b. The piercing member 130 is formed from a suitable metal, such a high temperature stainless steel which also offers high temperature conductivity for rapid heat dissipation from piercing during and after cooking to allow the piercing member to act as a gripping member for manipulation and carrying of the skewer system 100. The piercing member 130 has a generally tapered food piercing end section 132 terminating with a food piercing element 134a and an intermediate, generally cylindrical portion 134 having a diameter greater than the adjacent diameter of the flexible element 110. The greater diameter of the piercing member 130 relative to the flexible element 110 functions as an obstruction to food arranged on the flexible element 110 from separating from the skewer system 100, such as during manipulation of a cooking surface or carrying the skewer system to and from the cooking surface and from place to place. The tapered front piercing portion 132 insures effective piercing of food items for placement on the flexible element 110.

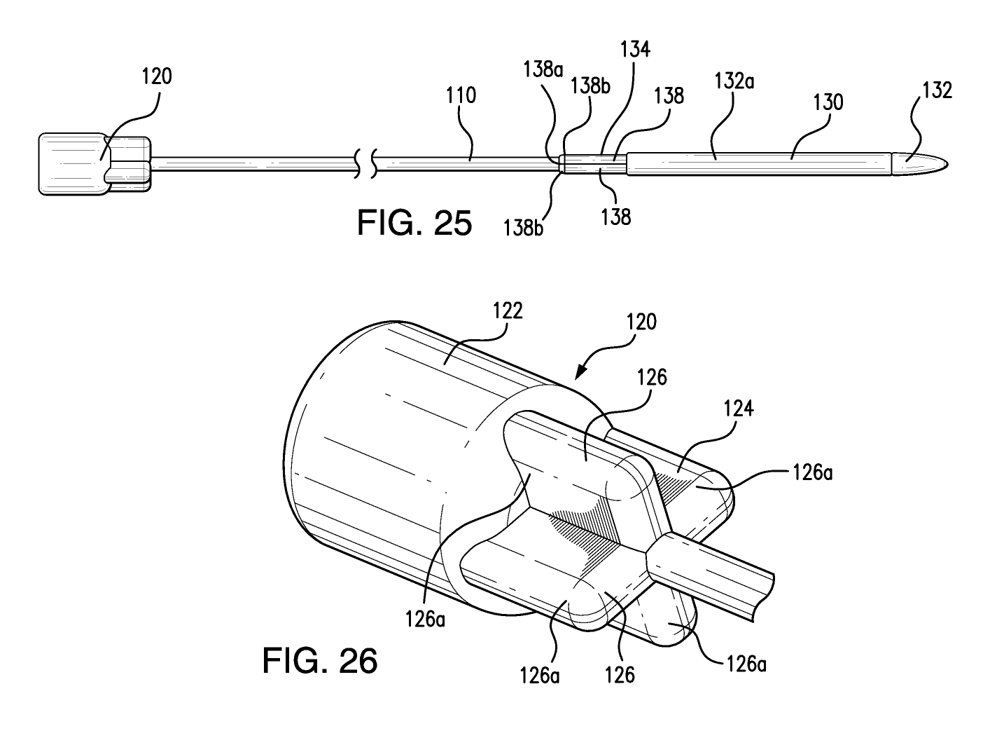

As seen on FIGS. 24 and 25, the inner end section 136 of piercing member 130 creates a unique interface between the enlarged intermediate portion 134 of piercing member 130 and the flexible element 110 to facilitate removal of cooked food items from the skewer system 100, which tend to shrink during the cooking process. The inner end section 136 of piercing member 130 is integral to intermediate portion 134 and has a reduced diameter relative to the intermediate portion 134. The surface of inner section 136 is formed with a plurality of circumferentially arranged, flat longitudinally extending faces 136a, such as, for example, five in number as shown, along a substantial extent of its length. It is within the scope of the invention to use other number of faces or extend them at angles with respect to the longitudinal axis, other than being parallel as shown in FIGS. 24 and 25. The inner end portion 138 of end section 136 is tapered toward flexible member 110 to form a ramp-like structure to modify the pierced opening through the cooked food items during relative movement for better removal from the skewer system 100 over piercing member 130. The effectiveness of removal of the cook food items from end portion 102b of skewer system 100 is enhanced by providing flat faces 138a on inner end portion 138 generally is alignment to flat faces 136a of inner end section 136 of the piercing member 130.

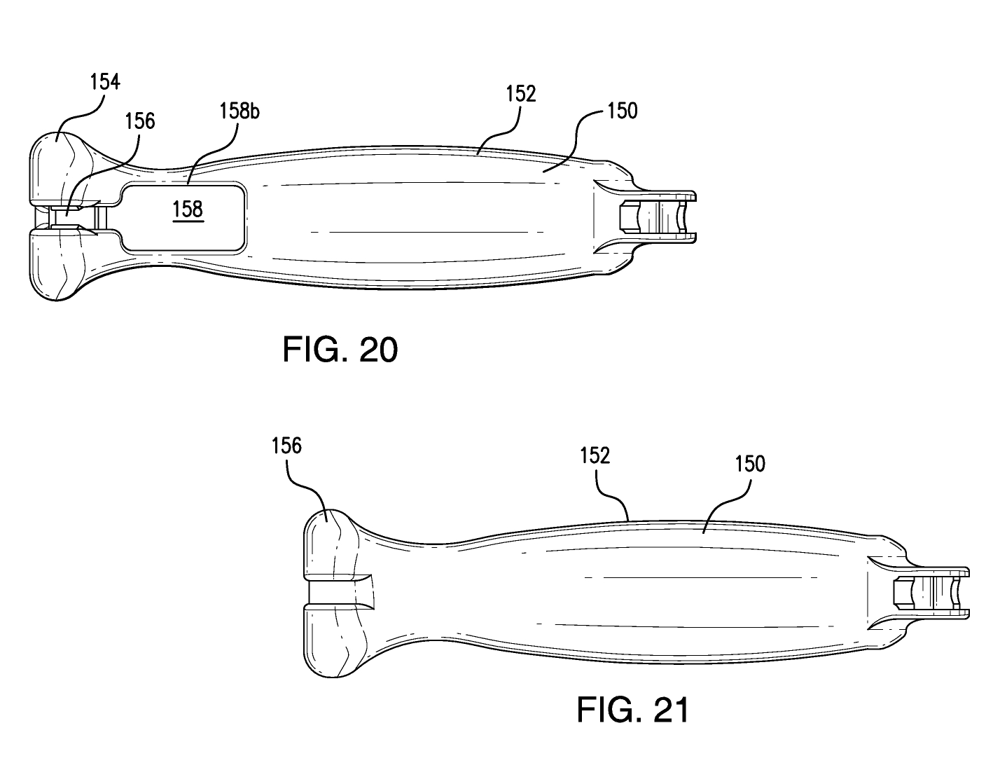

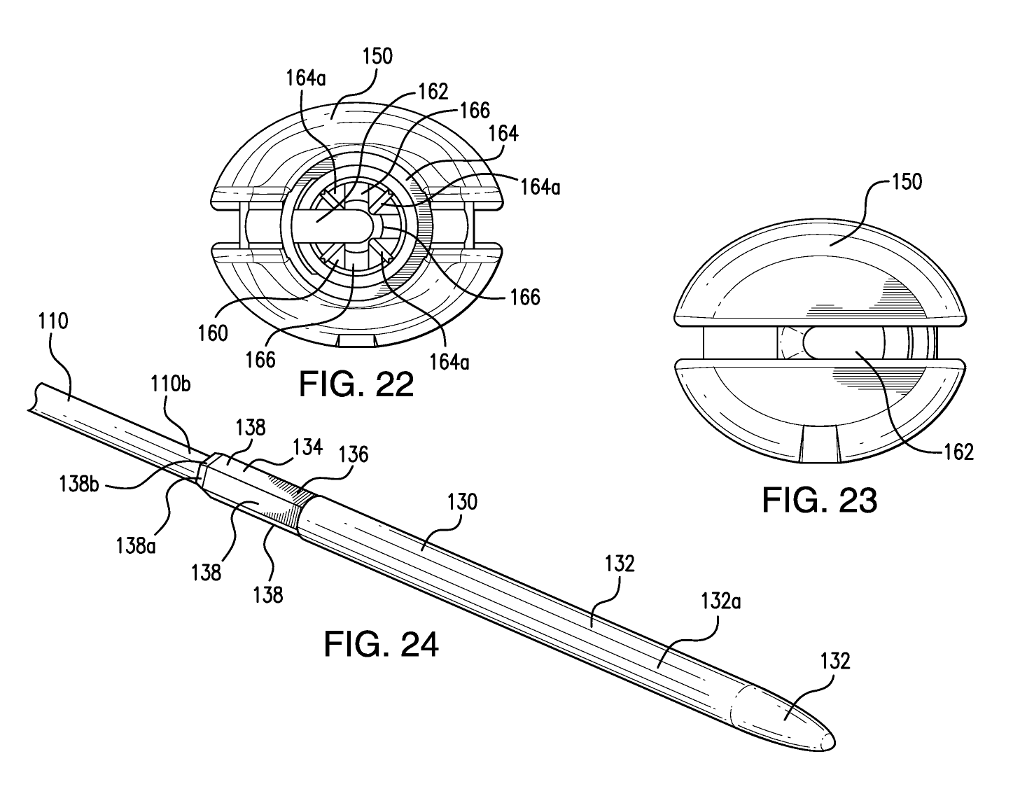

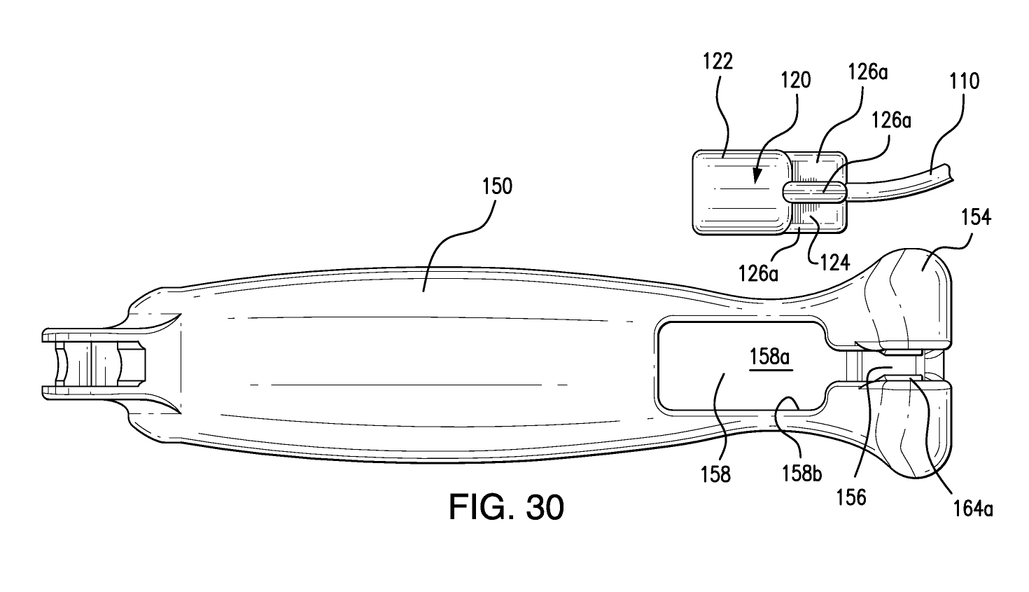

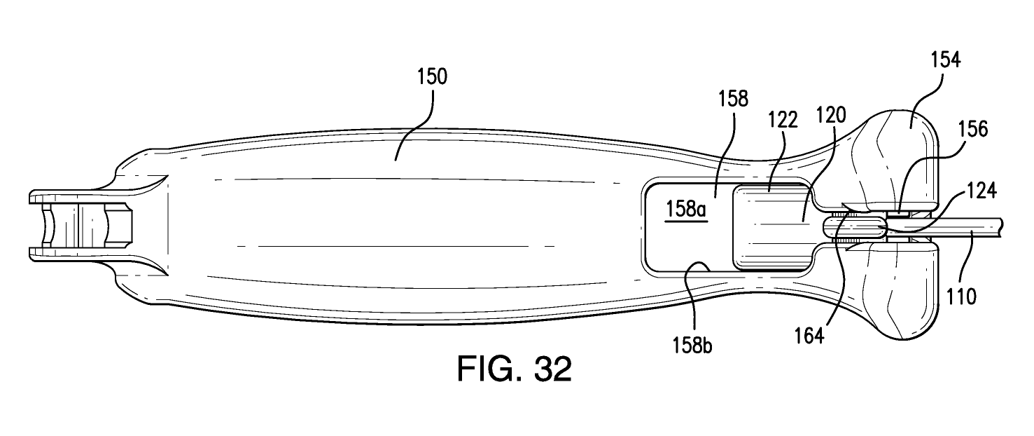

Referring to FIGS. 17-23, 31 and 32 the removable handle 150 is best shown. The removable handle is configured to be selectively being attachable to the food stop/connector 120 and is constructed from a metal, such as, for example, a high temperature resistant stainless steel and the like, a high temperature resistant plastic or other material. Other materials nor demonstrating high temperature resistant properties can use, if desired. The central portion 152 of the handle 150 has a variable circular cross section and an intermediate bulging mid-section 152a to created sculptured handle profile. The front end of the handle 150 adjacent flexible element 110 is formed with an enlarged neck 154 having an open lateral slot 156 (FIGS. 20 and 30-32). An open cavity 158 is provided in handle 150 adjacent the neck 154 formed by circumferentially wall 158a and in alignment with a connector access opening 158b that is also open to the longitudinally extending slot 156. The connector access opening 158b is of a size sufficient to permit the food stop/connector 120 to be inserted into and removed from cavity 158 as seen in FIGS. 30 and 32. The cavity 158 extends to the rear end of the removable handle 150 and terminates with a rear opening 160 (FIGS. 17 and 22). The food stop/connector 120 can therefore be alternatively pulled through rear opening 160 to a position adjacent the entrance of the forward neck 154.

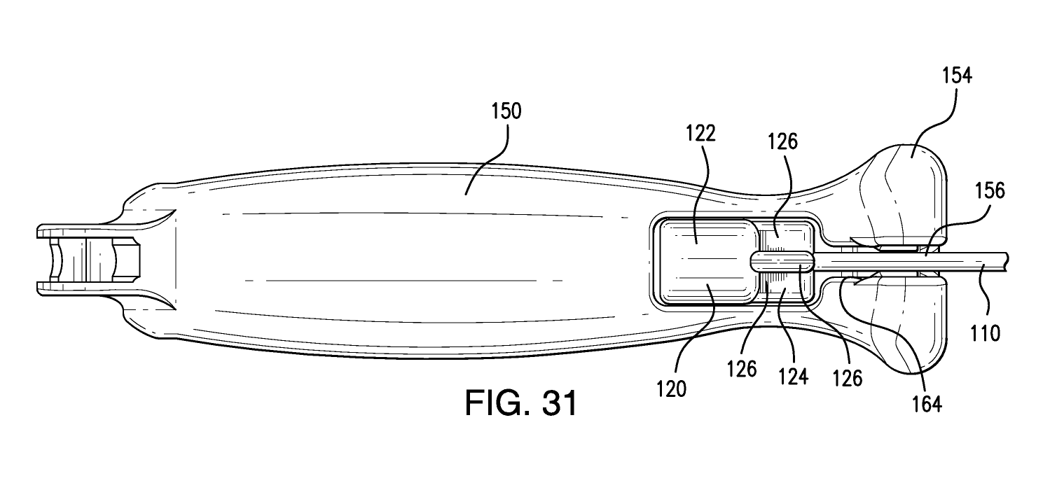

A through hole 162 in open alignment with lateral slot 156 and through which a portion of the flexible element 110 extends as seen in FIGS. 31 and 32 is formed in enlarged neck 154. A chamfer 164 extending for an extent of 360° is formed at the inner entrance to the enlarged neck 154 and serves a guide for the food stop/connector 120 as it inserted internally within the neck 154 through relative longitudinal movement (FIGS. 22 and 30). As further seen in FIGS. 22 and 30 a plurality of guide lugs 164a form key ways 166 to receive lugs 126 of food stop/connector 120 to retain the food stop/connector 120 against rotation in its fully inserted position as shown in FIGS. 17 and 32 that attaches the removable handle 150 to food stop/connector 120 and flexible element 110. The handle 150 can be attached to the food stop/connector 120 before food items are arranged on flexible element 110 by pulling the flexible element 110 through rear opening 160 until the food stop/connector 120 is inserted into the neck portion (FIG. 32) or by inserting the food stop/connector 120 through access opening 156b and pulling it into neck position as seen in FIG. 32. When the handle 150 is connected to the food skewer 100 before food items are positioned on the flexible element 110, its presence also serves as a food stop preventing accidental separation of the food items after they are attached. After food items are placed on flexible element 110, the handle 150 can be attached to the food stop/connector 120 through access opening 156b before cooking, during cooking and after cooking for carrying the food skewer 110 and further insuring that no food items are inadvertently separated at end portion 110b. As in the previous embodiments, the piercing member 130 and the food stop/connector 120, with or without the handle 150, suitably can be positioned away from the cooking surfaces to facilitate manipulation and carrying during and after cooking From the foregoing it should be apparent that the food skewer 100 can be manipulated on the grill or other cooking surface and also carried from place to place by gripping either the piercing member 130, the food stop/connector 120 (with or without handle 150) or both. The use of removable handle 150 does aid in the carrying of the skewer system 100 with ease and comfort during and after cooking

What is claimed is:

1. A cooking utensil, for retaining by sequential impalement thereon, one or more food items to be cooked, comprising:
an elongated flexible high-temperature resistant member having first and second ends;
a piercing member affixed to the first end of the elongated flexible high temperature resistant member; and
the second end of the elongated flexible high-temperature resistant member having a gripping loop formed thereon, and a retaining member disposed longitudinally between the gripping loop and a remaining portion of the flexible member.

2. A cooking utensil for one or more food items to be cooked comprising:
an elongated flexible high-temperature resistant member having first and second ends;
a piercing member affixed to the first end of the elongated flexible high temperature resistant member; and
the second end of the elongated flexible high-temperature resistant member having an enlarged end formed thereon and serving as a gripping member in use.

3. The cooking utensil according to claim 2 wherein said piercing member is formed form a material having a high thermal conductivity to increase heat dissipation and further serves as a second gripping member in use.

4. The cooking utensil according to claim 3 wherein said high-temperature resistant member is a metal cable.

5. The cooking utensil according to claim 4 wherein said metal cable is stainless steel.

6. The cooking utensil according to claim 5 wherein said piercing member is formed from stainless steel.

7. The cooking utensil according to claim 4 wherein said piercing member has a portion having a great diameter than the adjacent diameter of said flexible high-temperature resistant member to retain food on said high-temperature resistant member.

8. The cooking utensil according to claim 6 wherein a portion of said piercing adjacent member adjacent said high-temperature resistant member has a sloped outer configuration.

9. The cooking utensil according to claim 2 further comprising a handle being removably mounted on said enlarged end member.

10. The cooking utensil according to claim 9 wherein said handle has a cavity for removably receiving said enlarged end member.

11. The cooking utensil according to claim 9 wherein said handle includes an end opening through which said high-temperature resistant member extends.

12. The cooking utensil according to claim 11 wherein said housing has an open slot to permit insertion and removal of said second end of said high-temperature resistant member to and from said cavity.

13. The cooking utensil according to claim 12 wherein an interface is provided between said cavity and said end opening to axially retain said high-temperature resistant member to said handle.

14. The cooking utensil according to claim 13 wherein said interface includes at least one slot, said enlarged end having at least one key to engage said groove.

15. A cooking utensil for one or more food items to be cooked comprising:
an elongated flexible high-temperature resistant member having first and second ends;
a piercing member affixed to the first end of the elongated flexible high temperature resistant member; and
the second end of the elongated flexible high-temperature resistant member having a handle to serve as a gripping member in use.

16. The cooking utensil according to claim 15 wherein a portion of said handle is removably mounted.

17. A cooking utensil, for retaining, manipulating and preparing by sequential impalement thereon, one or more food items to be cooked, comprising:
a slender pliant system formed as a flexible high-temperature resistant material having first and second ends;
a piercing member having a tapered portion is affixed to the first end of the slender pliant system, and
the second end of the slender pliant system having an enlarged end formed thereon and serving as a food retaining and gripping member in use.

18. The cooking utensil according to claim 17 wherein said tapered piercing member is formed from a high temperature resistant material and further serves as a food retaining member in use.

19. The cooking utensil according to claim 18 wherein said piercing member is formed from stainless steel.

20. The cooking utensil according to claim 17 wherein said piercing member has a portion having a great diameter than the adjacent diameter of said slender pliant system to retain food on said slender pliant system.
